(19) United States
(12) Patent Application Publication
(10) Pub. No.: US 2026/0084990 A1
(43) Pub. Date: Mar. 26, 2026

(54) LOW-CARBON AND ROBUST PARTIAL NITRIFICATION PROCESS

(71) Applicant: Zhihe Environmental Science and Technology Co., Ltd, Zhengzhou City (CN)

(72) Inventors: Haisong LI, Zhengzhou City (CN); Dengke YAN, Zhengzhou City (CN); Yanyan FAN, Zhengzhou City (CN); Zicong XU, Zhengzhou City (CN); Denghui WEI, Zhengzhou City (CN); Zhimeng ZHANG, Zhengzhou City (CN)

(21) Appl. No.: 19/339,647

(22) Filed: Sep. 25, 2025

(30) Foreign Application Priority Data
Sep. 26, 2024 (CN) 202411345494.7

(51) Int. Cl. C02F 3/30

(52) U.S. Cl. CPC C02F 3/307; C02F 2209/005

(57) ABSTRACT

A robust partial nitrification process includes using a partial nitrification reactor, an operation control system, and a safeguard system, where the partial nitrification reactor includes a water inlet pipe, a water distributor, a partial nitrification filler, and a triangular weir; the operation control system includes an on-line ammonia nitrogen monitoring probe, an on-line dissolved oxygen monitoring probe, an operation control center, a variable-frequency micro-nano aerator, a circulating water tank, a circulating pump, and an external circulating pipeline; and the safeguard system includes the on-line ammonia nitrogen monitoring probe, an on-line effluent nitrate nitrogen monitoring probe, a safeguard control center, a dosing peristaltic pump, and a safeguard chemical.

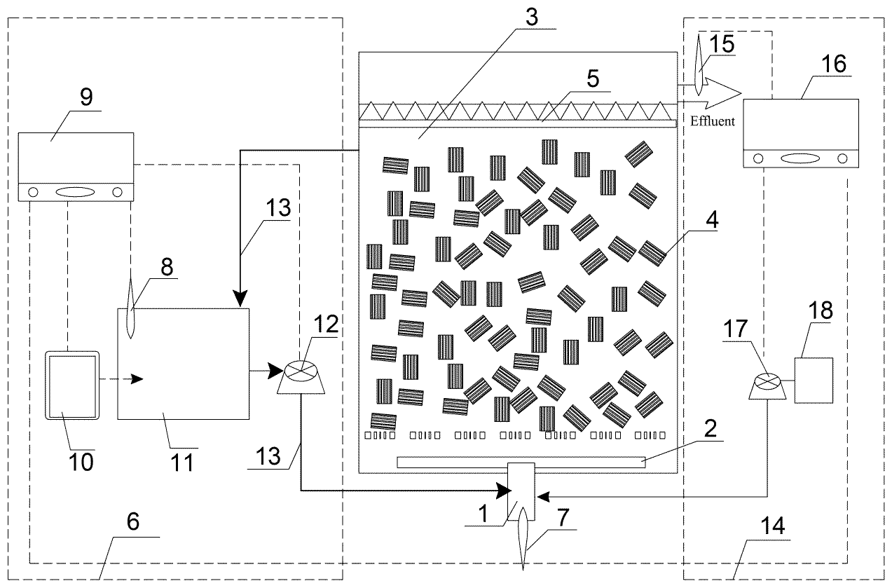

### CROSS REFERENCE TO RELATED APPLICATION

This patent application claims the benefit and priority of Chinese Patent Application No. 202411345494.7 filed with the China National Intellectual Property Administration on Sep. 26, 2024, the disclosure of which is incorporated by reference herein in its entirety as part of the present application.

### TECHNICAL FIELD

The present disclosure belongs to the technical field of water treatment, and in particular to a low-carbon and robust partial nitrification process, which is suitable for treatment of various ammonia nitrogen-containing wastewater.

### BACKGROUND

Compared with conventional nitrogen removal process, a variety of novel nitrogen removal processes, such as partial nitrification-denitrification (PND) and partial nitrification-anaerobic ammonia oxidation (PNA), can reduce aeration energy consumption and carbon source dosage by shortening a nitrogen conversion path, thereby reducing carbon emissions. Partial nitrification is the basis for implementing the novel nitrogen removal process. To achieve partial nitrification, it is necessary to strictly control parameters such as an aeration rate, a dissolved oxygen (DO) concentration, a free ammonia (FA) concentration, a free nitrite (FNA) concentration, and pH to inhibit the activity of nitrite-oxidizing bacteria (NOB). However, the existing partial nitrification processes still face challenges such as complex control requirements and difficulties in maintaining long-term stable operation.

In addition, under the severe challenge of global climate change, nitrous oxide (N₂O) is a critical greenhouse gas, and emission task in the biological nitrogen removal process in wastewater treatment has become an urgent problem for the environmental protection industry to overcome. To ensure the long-term inhibition on NOB, the DO concentration in the existing partial nitrification process is generally controlled at 0.5 mg/L to 2 mg/L. However, the lack of DO concentration leads to the limited oxidation of hydroxylamine, resulting in a multifold increase in N₂O production in the partial nitrification process. In addition, the use of conventional aeration, which provides (millimeter-sized) macro-bubbles with a short retention time in the liquid phase, results in low dissolved oxygen utilization efficiency and high energy consumption. Meantime, the macro-bubbles introduced by the conventional aeration create turbulence in the liquid phase, which exacerbates the release of N₂O into the atmosphere.

The present disclosure provides a low-carbon and robust partial nitrification process. Pre-oxygen supply through microbubbles not only can improve DO utilization efficiency and reduce the energy consumption of treatment, but also can effectively reduce the generation and release of N₂O by controlling the DO concentration in the reaction system. Combined with multi-path coupling, the activity of NOB is inhibited to achieve low-carbon, long-term, and stable partial nitrification.

### SUMMARY

For the problems that the existing partial nitrification process is poor in long-term operational stability, low in DO utilization efficiency, and high in greenhouse gas production and emissions, the present disclosure provides a low-carbon and robust partial nitrification process. The present disclosure provides the following technical solutions.

The present disclosure provides a low-carbon and robust partial nitrification process, including using the following three parts: a partial nitrification reactor, an operation control system, and a safeguard system.

The partial nitrification reactor is configured to conduct partial nitrification reaction. A partial nitrification filler is added into the partial nitrification reactor such that an amount of microbial biomass in the partial nitrification reactor ranges from 3 g/L to 5 g/L. An external circulation mode is used to maintain oxygen supply and mixing conditions in the partial nitrification reactor, providing an upflow velocity of 10 m/h to 20 m/h and a dissolved oxygen concentration of 3.5 mg/L to 5.5 mg/L. The partial nitrification reactor employs continuous water feeding, and a pH value in the partial nitrification reactor is controlled in a range from 8.0 to 9.0 by the safeguard system.

The operation control system is configured to control an operation procedure of the partial nitrification reactor. An internal control logic of the operation control system is as follows: (1) an on-line ammonia nitrogen monitoring probe and an on-line DO monitoring probe in a circulating water tank are configured to send monitored data to the operation control center; (2) the operation control center is to calculate power and aeration time of an aerator and a circulating flow rate of a circulating pump based on input data and a specified ammonia nitrogen conversion rate; and (3) the operation control center is to regulate and control a variable-frequency micro-nano aerator and the circulating pump through feedback data.

The safeguard system is configured to ensure long-term and stable operation of the partial nitrification reactor. A safeguard control center is to regulate and control a dosing peristaltic pump to add a safeguard chemical quantitatively, thereby ensuring long-term and stable operation of the partial nitrification reactor. An internal control logic of the safeguard system is as follows: (1) the on-line ammonia nitrogen monitoring probe and an on-line effluent nitrate nitrogen monitoring probe are configured to send monitored data to the safeguard control center; (2) the safeguard control center is to calculate a nitrate nitrogen accumulation rate based on input data, and to determine whether the nitrate nitrogen accumulation rate exceeds a specified range; and (3) the safeguard control center is to set a dosage of the safeguard chemical based on a determining result, and to regulate and control the dosing peristaltic pump for dosing.

In some embodiments, the ammonia nitrogen conversion rate of the partial nitrification reactor and the circulating flow rate of the circulating pump are determined by a downstream process. Under a condition that the partial nitrification process is coupled with an anammox at a downstream stage, the ammonia nitrogen conversion rate of the partial nitrification reactor is set at 50% to 60%, and by the operation control center, oxygen supply is calculated and the circulating flow rate of the circulating pump is regulated and controlled on the basis of an oxygenation coefficient of 3.45 to 3.55 mg O₂/mg ammonia nitrogen. Under a condition that the partial nitrification process is coupled with denitrification at a downstream stage, the ammonia nitrogen conversion rate of the partial nitrification reactor is set at not less than 80%, and by the operation control center, oxygen supply is calculated and the circulating flow rate of the circulating pump is regulated and controlled on the basis of an oxygenation coefficient of 4.55 to 4.65 mg O₂/mg ammonia nitrogen.

In some embodiments, the nitrate accumulation rate is not greater than 10%.

In some embodiments, a dosage of the safeguard chemical is determined based on data calculated by the safeguard control center. Under a condition that the nitrate accumulation rate exceeds the specified range, the dosage of the safeguard chemical is increased to 2 times to 3 times a dosage that the nitrate accumulation rate is within the specified range until the nitrate accumulation rate is restored to the specified range.

In some embodiments, the safeguard chemical includes, as a main component, one or more selected from the group consisting of sodium bicarbonate, sodium carbonate, sodium hydroxide, sodium chloride, and potassium chloride, and the safeguard chemical after being added into the partial nitrification reactor has a concentration of 4 g/L to 7 g/L.

The partial nitrification process is suitable for treatment of various ammonia nitrogen-containing wastewater.

A further improvement of the present disclosure is that when employing conventional aeration for oxygen supply in the partial nitrification reaction, there is a problem of insufficient aeration uniformity. In the present disclosure, a pre-aeration mode for oxygen supply is used, gas and liquid are sufficiently mixed and introduced into the partial nitration reactor, which can greatly improve the oxygen supply homogeneity and improve gas-liquid-solid mass transfer efficiency. Compared with the conventional oxygen supply mode, oxygen in the present disclosure exists in the form of micro-nano bubbles, making the retention time longer. In addition, residual DO in the effluent is effectively utilized through external circulation, which can significantly improve the DO utilization efficiency of the partial nitrification reactor. Pre-aeration and effluent circulation mode are coupled for oxygen supply, and an aeration frequency and aeration time are controlled by the operation control system, thereby achieving precise oxygen supply and effectively reducing the energy consumption of oxygen supply. Compared with a commonly used control mode of achieving partial nitrification with low DO, coupling of alkaline inhibition and salinity inhibition can inhibit activity of NOB for a long time, thereby achieving long-term stable operation of the partial nitrification. The oxygen supply by micro-nano pre-aeration can ensure sufficient DO in a partial nitrification system, which can alleviate oxidation limitation of hydroxylamine due to low DO in the existing partial nitrification control process and reduce N₂O production. In addition, oxygen is supplied in the form of microbubbles, which can effectively avoid N₂O release caused by macro-bubble turbulence.

Some embodiments of the present disclosure have characteristics as follows:

In the present disclosure, a combination of micro-nano pre-aeration and external circulation for oxygen supply is used, achieving higher oxygen supply homogeneity. A reaction rate and DO utilization efficiency within a partial nitrification reactor are improved, and precise oxygen supply is achieved, which effectively reduces energy consumption of oxygen supply and carbon emission. By employing a combination of pre-aeration and external circulation for oxygen supply, a DO concentration within the partial nitrification reactor is ensured, and the release of N₂O caused by bubble turbulence is avoided, so that a N₂O emission factor of the partial nitrification process is effectively reduced, and low-carbon partial nitrification is achieved. By coupling alkalinity inhibition and salinity inhibition, the activity of nitrite-oxidizing bacteria (NOB) can be effectively inhibited, thereby ensuring the long-term and stable operation of the partial nitrification.

### BRIEF DESCRIPTION OF THE DRAWINGS

The sole FIGURE is a diagram showing the low-carbon and robust partial nitrification process according to an embodiment of the present disclosure.

Reference numerals are as follows:
1 represents water inlet pipe; 2 represents water distributor; 3 represents partial nitrification reactor; 4 represents partial nitrification filler; 5 represents triangular weir; 6 represents operation control system; 7 represents on-line ammonia nitrogen monitoring probe; 8 represents on-line dissolved oxygen monitoring probe; 9 represents operation control center; 10 represents variable-frequency micro-nano aerator; 11 represents circulating water tank; 12 represents circulating pump; 13 represents external circulating pipeline; 14 represents safeguard system; 15 represents on-line effluent nitrate nitrogen monitoring probe; 16 represents safeguard control center; 17 represents dosing peristaltic pump; and 18 represents safeguard chemical.

### DETAILED DESCRIPTION

The present disclosure is further described below with reference to accompanying drawings and instances.

The sole FIGURE is a diagram showing the low-carbon and robust partial nitrification process according to an embodiment of the present disclosure.

A partial nitrification process is established as shown in the sole FIGURE, which is performed as follows.

Sewage is introduced into a water inlet pipe 1 and then introduced into a partial nitrification reactor 3 via a water distributor 2. A partial nitrification filler 4 is added into the partial nitrification reactor 3 and then subjected to partial nitrification reaction, and a resulting reaction effluent flows out through a triangular weir 5. The partial nitrification reactor 3 is controlled by the operation control system 6, with a specific control process as follows: circulating water is introduced into a circulating water tank through an external circulating pipeline 13, an on-line ammonia nitrogen monitoring probe 7 placed in the water inlet pipe 1 and an on-line dissolved oxygen monitoring probe 8 placed in the circulating water tank 11 are configured to feed back data monitored in real time to an operation control center 9. Based on feedback data and a specified ammonia nitrogen conversion rate, the operation control center 9 regulates and controls operation power and operation time of a variable-frequency micro-nano aerator 10, and regulates a circulating flow rate of a circulating pump 12. Circulating water containing high-concentration dissolved oxygen is pumped out by the circulating pump 12, and enters the partial nitrification reactor through the external circulating pipeline 13 for oxygen supply. The safeguard system 14 is configured to ensure long-term and stable operation of the partial nitrification reactor 3, with a specific control process as follows: the on-line ammonia nitrogen monitoring probe 7 placed in the water inlet pipe 1 and an on-line effluent nitrate nitrogen monitoring probe 15 arranged at a water outlet are configured to feedback data monitored in real time to the safeguard control center 16. The safeguard control center 16 is configured to determine whether a nitrate accumulation rate exceeds a specified range based on feedback data and calculation, and to control a dosing peristaltic pump 17 to add safeguard chemicals 18 into the partial nitrification reactor 3 based on a determining result, thereby achieving long-term stable and robust operation of partial nitrification.

### Example 1

The partial nitrification process provided by the present disclosure was used to treat wastewater from a chemical plant, and an ammonia nitrogen concentration of the wastewater was 100 mg/L. A cylindrical partial nitrification reactor with a diameter of 0.3 m and a height of 0.8 m was built based on the technical solution of the partial nitrification process, and a partial nitrification filler was added into the cylindrical partial nitrification reactor to make biomass in the cylindrical partial nitrification reactor be 4.5 g/L.

In this example, a downstream process was a denitrification process. An ammonia nitrogen conversion rate of the partial nitrification reactor was set at 90%, an oxygenation coefficient was set at 4.60 mg O₂/mg ammonia nitrogen, hydraulic retention time was set at 5 hours, an upflow velocity in the cylindrical partial nitrification reactor was about 14.7 m/h, and a DO concentration in the cylindrical partial nitrification reactor was ensured to be about 5 mg/L. A composition of the safeguard chemical is sodium carbonate. A concentration of the safeguard chemical in the partial nitrification reactor after dosing was 5 g/L, with a dosing rate of 1.6 L/h. A pH value in the cylindrical partial nitrification reactor was controlled at approximately 8.5. When a nitrate accumulation rate exceeded 10%, a dosage of the safeguard chemical was increased to 3.2 L/h. Concentrations of ammonia nitrogen, nitrite nitrogen, and nitrate nitrogen in both influent and effluent, as well as N₂O emission flux from the cylindrical partial nitrification reactor of the partial nitrification system within half a year were monitored, and the ammonia nitrogen conversion rate, the nitrate nitrogen accumulation rate, and an N₂O emission factor were calculated, with specific data shown in Table 1.

TABLE 1
Monitoring data of Example 1 (Average data for 6 months)

| Ammonia | Ammonia | Nitrite | Nitrite | Nitrate | Nitrate |
|---|---|---|---|---|---|
| nitrogen in | nitrogen in | nitrogen in | nitrogen in | nitrogen in | nitrogen in |
| influent | effluent | influent | effluent | influent | effluent |
| (mg/L) | (mg/L) | (mg/L) | (mg/L) | (mg/L) | (mg/L) |
| 99.4 ± 0.6 | 9.9 ± 0.3 | 0.0 ± 0.0 | 80.8 ± 2.3 | 0.5 ± 0.1 | 8.6 ± 0.5 |

| Ammonia nitrogen | Nitrate | N₂O emission factor |
|---|---|---|
| conversion rate | accumulation | (kg N₂O/kg TN |
| (%) | rate (%) | removed) |
| 90.0 ± 0.6 | 8.7 ± 0.8 | 0.0102 |

### Example 2

A partial nitrification process similar to that in Example 1 was performed.

In this example, a downstream process was an anammox process. An ammonia nitrogen conversion rate of the partial nitrification reactor was set at 55%, an oxygenation coefficient was set at 3.47 mg O₂/mg ammonia nitrogen, hydraulic retention time was set at 3 hours, an upflow velocity in the reactor was about 20.6 m/h, and a DO concentration in the partial nitrification reactor was ensured to be about 4.5 mg/L. A composition of the safeguard chemical is sodium carbonate and sodium chloride. A concentration of the safeguard chemical in the partial nitrification reactor after dosing is 6 g/L, with a dosing rate of 4.5 L/h. A pH value in the partial nitrification reactor was controlled at approximately 8.5. When a nitrate accumulation rate exceeds 10%, a dosage of the safeguard chemicals was increased to 9.0 L/h. Concentrations of ammonia nitrogen, nitrite nitrogen, and nitrate nitrogen in both influent and effluent, as well as N₂O emission flux from the partial nitrification reactor of the partial nitrification system within half a year were monitored, and the ammonia nitrogen conversion rate, the nitrate nitrogen accumulation rate, and an N₂O emission factor were calculated, with specific data shown in Table 2.

TABLE 2
Monitoring data of Example 2 (Average data for 6 months)

| Ammonia | Ammonia | Nitrite | Nitrite | Nitrate | Nitrate |
|---|---|---|---|---|---|
| nitrogen in | nitrogen in | nitrogen in | nitrogen in | nitrogen in | nitrogen in |
| influent | effluent | influent | effluent | influent | effluent |
| (mg/L) | (mg/L) | (mg/L) | (mg/L) | (mg/L) | (mg/L) |
| 99.4 ± 0.6 | 43.8 ± 1.3 | 0.0 ± 0.0 | 48.0 ± 1.6 | 0.5 ± 0.1 | 7.4 ± 0.4 |

| Ammonia nitrogen | Nitrate | N₂O emission factor |
|---|---|---|
| conversion rate | accumulation | (kg N₂O/kg TN |
| (%) | rate (%) | removed) |
| 55.9 ± 0.5 | 7.4 ± 0.7 | 0.0098 |

### Comparative Example 1

A conventional partial nitrification process was used to treat wastewater from a chemical plant, and an ammonia nitrogen concentration of the wastewater was 100 mg/L. A cylindrical partial nitrification reactor with a diameter of 0.3 m and a height of 0.8 m was built, and a partial nitrification filler was added into the cylindrical partial nitrification reactor to make biomass in the reactor be 4.5 g/L. The conventional partial nitrification process employed bottom aeration as an aeration mode, where an aerator was a microporous aerator.

In this comparative example, a downstream process was a denitrification process. An ammonia nitrogen conversion rate of the cylindrical partial nitrification reactor was set at 90%, hydraulic retention time was set at 5 hours, a DO concentration in the cylindrical partial nitrification reactor was ensured to be about 5 mg/L, and a pH value in the cylindrical partial nitrification reactor was controlled at approximately 8.5. Concentrations of ammonia nitrogen, nitrite nitrogen, and nitrate nitrogen in both influent and effluent, as well as N₂O emission flux from the cylindrical partial nitrification reactor of the partial nitrification system within half a year were monitored, and the ammonia nitrogen conversion rate, the nitrate nitrogen accumulation rate, and an N₂O emission factor were calculated, with specific data shown in Table 3.

TABLE 3
Monitoring data of Comparative Example
1 (Average data for 6 months)

| Ammonia | Ammonia | Nitrite | Nitrite | Nitrate | Nitrate |
|---|---|---|---|---|---|
| nitrogen in | nitrogen in | nitrogen in | nitrogen in | nitrogen in | nitrogen in |
| influent | effluent | influent | effluent | influent | effluent |
| (mg/L) | (mg/L) | (mg/L) | (mg/L) | (mg/L) | (mg/L) |
| 99.4 ± 0.6 | 10.5 ± 0.4 | 0.0 ± 0.0 | 71.9 ± 1.9 | 0.5 ± 0.1 | 16.7 ± 0.4 |

| Ammonia nitrogen | Nitrate | N₂O emission factor |
|---|---|---|
| conversion rate | accumulation | (kg N₂O/kg TN |
| (%) | rate (%) | removed) |
| 89.4 ± 0.6 | 16.8 ± 1.1 | 0.0183 |

### Comparative Example 2

A partial nitrification process similar to that in Comparative Example 1 was performed.

In this comparative example, a downstream process was an anammox process. An ammonia nitrogen conversion rate of the partial nitrification reactor was set at 55%, hydraulic retention time was set at 3 hours, a DO concentration in the partial nitrification reactor was ensured to be about 4.5 mg/L, and a pH value in the reactor was controlled at approximately 8.5. Concentrations of ammonia nitrogen, nitrite nitrogen, and nitrate nitrogen in both influent and effluent, as well as N₂O emission flux from the partial nitrification reactor of the partial nitrification system within half a year were monitored, and the ammonia nitrogen conversion rate, the nitrate nitrogen accumulation rate, and an N₂O emission factor were calculated, with specific data shown in Table 4.

TABLE 4
Monitoring data of Comparative Example
2 (Average data for 6 months)

| Ammonia | Ammonia | Nitrite | Nitrite | Nitrate | Nitrate |
|---|---|---|---|---|---|
| nitrogen in | nitrogen in | nitrogen in | nitrogen in | nitrogen in | nitrogen in |
| influent | effluent | influent | effluent | influent | effluent |
| (mg/L) | (mg/L) | (mg/L) | (mg/L) | (mg/L) | (mg/L) |
| 99.4 ± 0.6 | 48.2 ± 1.3 | 0.0 ± 0.0 | 35.6 ± 1.7 | 0.5 ± 0.1 | 15.4 ± 0.8 |

| Ammonia nitrogen | Nitrate | N₂O emission factor |
|---|---|---|
| conversion rate | accumulation | (kg N₂O/kg TN |
| (%) | rate (%) | removed) |
| 51.5 ± 0.7 | 15.5 ± 1.1 | 0.0169 |

In terms of stability, after six months of operation, the partial nitrification processes in Example 1 and Example 2 can maintain efficient nitrite nitrogen accumulation, where the ammonia nitrogen conversion rates are 90.0%±0.6% and 55.9%±0.5%, respectively, which are basically the same as the set values, and the nitrate nitrogen accumulation rates are 8.7%±0.8% and 7.4%±0.7%, respectively, which are lower than the control range. However, in Comparative Example 1 and Comparative Example 2, the ammonia nitrogen conversion rates are 89.4%±0.6% and 51.5%±0.7%, respectively, which are apparently different from the set values, and the nitrate nitrogen accumulation rates are 16.8%±1.1% and 15.5%±1.1%, respectively, which are significantly higher than the control range, indicating that the partial nitrification process according to the present disclosure has high operational stability and can operate stably for a long time. In addition, compared with Comparative Example 1 and Comparative Example 2, the N₂O emission factors are 0.0183 kg N₂O/kg TN removed and 0.0169 kg N₂O/kg TN removed, respectively, and in Example 1 and Example 2, the N₂O emission factors are 0.0102 kg N₂O/kg TN removed and 0.0098 kg N₂O/kg TN removed, respectively, exhibiting the efficacy of the partial nitrification process provided by the present disclosure in reducing emissions of the greenhouse gas N₂O. By comprehensively comparing the partial nitrification process in the present disclosure with the conventional partial nitrification process, the partial nitrification process provided by the present disclosure can achieve low-carbon, and long-term and stable operation, and has a higher engineering application value.

What is claimed:

1. A robust partial nitrification process, comprising:
using a partial nitrification reactor, an operation control system, and a safeguard system, wherein the partial nitrification reactor comprises a water inlet pipe, a water distributor, a partial nitrification filler, and a triangular weir, the operation control system comprises an on-line ammonia nitrogen monitoring probe, an on-line dissolved oxygen monitoring probe, an operation control center, a variable-frequency micro-nano aerator, a circulating water tank, a circulating pump, and an external circulating pipeline, the on-line ammonia nitrogen monitoring probe being located at the water inlet pipe, and the on-line dissolved oxygen monitoring probe being arranged in the circulating water tank, and the safeguard system comprises the on-line ammonia nitrogen monitoring probe, an on-line effluent nitrate nitrogen monitoring probe, a safeguard control center, a dosing peristaltic pump, and a safeguard chemical, the on-line effluent nitrate nitrogen monitoring probe being located at a water outlet;
performing the robust partial nitrification process by:
introducing sewage into the water inlet pipe and the partial nitrification reactor through the water distributor;
adding the partial nitrification filler into the partial nitrification reactor and conducting partial nitrification reaction, and discharging a resulting reaction effluent through the triangular weir;
controlling and operating the partial nitrification reactor by the operation control system; and
ensuring long-term and stable operation of the partial nitrification reactor by the safeguard system;
wherein:
controlling and operating the partial nitrification reactor is conducted by:
introducing circulating water into the circulating water tank through the external circulating pipeline, feeding back first data monitored in real time to the operation control center by the on-line ammonia nitrogen monitoring probe and the on-line dissolved oxygen monitoring probe;
regulating and controlling operation power and operation time of the variable-frequency micro-nano aerator by the operation control center on the basis of first feedback data and a specified ammonia nitrogen conversion rate, and regulating a circulating flow rate of the circulating pump; and
pumping out circulating water containing dissolved oxygen by the circulating pump, and introducing the circulating water containing the dissolved oxygen into the partial nitrification reactor through the external circulating pipeline for oxygen supply; and
ensuring the long-term and stable operation of the partial nitrification reactor is conducted by:
feeding back second data monitored in real time to the safeguard control center by the on-line ammonia nitrogen monitoring probe and the on-line nitrate nitrogen monitoring probe;
determining whether a nitrate accumulation rate exceeds a specified range by the safeguard control center on the basis of second feedback data and calculation; and
controlling the dosing peristaltic pump according to a determined result and adding the safeguard chemical into the partial nitrification reactor, thereby achieving the long-term and stable operation of partial nitrification.

2. The process of claim 1, wherein:
the partial nitrification filler is added into the partial nitrification reactor such that an amount of microbial biomass in the partial nitrification reactor ranges from 3 g/L to 5 g/L;
an external circulation mode is used to maintain oxygen supply and mixing conditions in the partial nitrification reactor, providing an upflow velocity of 10 m/h (meter/hour) to 20 m/h and a dissolved oxygen concentration of 3.5 mg/L to 5.5 mg/L; and
a pH value in the partial nitrification reactor is controlled in a range from 8.0 to 9.0 by the safeguard system.

3. The process of claim 1, wherein, under a condition that the partial nitrification process is coupled with an anammox at a downstream stage, the specified ammonia nitrogen conversion rate in the partial nitrification reactor is set at 50% to 60%, and the circulation flow rate of the circulating pump is calculated and regulated and controlled by the operation control center on the basis of an oxygenation coefficient of 3.45 to 3.55 mg O₂/mg ammonia nitrogen.

4. The process of claim 1, wherein, under a condition that the partial nitrification process is coupled with a denitrification at a downstream stage, the specified ammonia nitrogen conversion rate in the partial nitrification reactor is set at not less than 80%, and the circulation flow rate of the circulating pump is calculated and regulated and controlled by the operation control center on the basis of an oxygenation coefficient of 4.55 to 4.65 mg O₂/mg ammonia nitrogen.

5. The process of claim 1, wherein the nitrate accumulation rate is not greater than 10%.

6. The process of claim 1, wherein:
a dosage of the safeguard chemical is determined on the basis of data calculated by the safeguard control center; and
under a condition that the nitrate accumulation rate exceeds the specified range, the dosage of the safeguard chemical is increased to 2 times to 3 times a dosage that the nitrate accumulation rate does not exceed the specified range until the nitrate accumulation rate is restored to the specified range.

7. The process of claim 1, wherein:
the safeguard chemical comprises, as a main component, one or more selected from the group consisting of sodium bicarbonate, sodium carbonate, sodium hydroxide, sodium chloride, and potassium chloride; and
the safeguard chemical, after being added into the partial nitrification reactor, has a concentration of 4 g/L to 7 g/L.
